(19) United States
(12) Patent Application Publication
(10) Pub. No.: US 2009/0206750 A1
(43) Pub. Date: Aug. 20, 2009

(54) Method for the Production of an Electroluminescence Apparatus and an Electroluminescence Apparatus Produced According to Said Method

(75) Inventors: Heidi Knechtli, Rheineck (CH); Emil Enz, Gais (CH)

Correspondence Address: PAULEY PETERSEN & ERICKSON, 2800 WEST HIGGINS ROAD, SUITE 365, HOFFMAN ESTATES, IL, 60169, US

(73) Assignee: SST Smart Surface Technology AG, Gais (CH)

(21) Appl. No.: 12/226,958

(22) PCT Filed: Apr. 30, 2007
(86) PCT No.: PCT/CH2007/000209

§ 371 Date: Apr. 30, 2009

(30) Foreign Application Priority Data
May 2, 2006 (CH) 715/06

(51) Int. Cl. H01J 1/62; H01J 9/00

(52) U.S. Cl. 313/506; 445/58

(57) ABSTRACT

An electroluminescence apparatus (10, 10′, 10″) having a layer sequence (12, 13, 14), which is arranged on a substrate (15) and has two electrode layers (12, 14), and an optically active dielectric intermediate layer (13) which is located between the electrode layers (12, 14) and is prepared by detachably applying the layer sequence (12, 13, 14) to an auxiliary mount (11) and adhesively applying the layer sequence (12, 13, 14) to the substrate (15) with the face which faces away from the auxiliary mount (11) of the layer sequence (12, 13, 14) which is located on the auxiliary mount (11) and detaching the auxiliary mount (11) from the layer sequence (12, 13, 14), which adheres to the substrate (15).

### BACKGROUND OF THE INVENTION

1. Field of the Invention

The present invention relates to the field of electroluminescence lamps and displays, which are designed on the principle of an electrical capacitor. The invention relates to a method for the production of a luminescence apparatus as claimed in the precharacterizing clause of claim 1, and to a luminescence apparatus produced according to the method.

2. Prior Art

Electroluminescence lamps and displays which are designed on the principle of an electrical capacitor and have a dielectric intermediate layer which is arranged between two electrodes and can be excited to illuminate by an AC voltage of, for example, 100 V have been known for a relatively long time and are being increasingly used for everyday purposes because of their simple design and versatile usage options. For example, they can be used for illumination purposes in automobiles (see for example WO-A1-03/037039 or US-A1-2006/0061138) or for illuminated labels (see for example U.S. Pat. No. B1-6,624,569) or as flexible lighting which can be applied to a fabric or the like (see for example WO-A1-98/30069).

The layer sequence which is actually optically active and comprises a rear electrode, an intermediate layer and a (transparent) front electrode is normally applied to a mechanically robust substrate, for example a flexible film, and is used together with the substrate (see for example U.S. Pat. No. 5,019,748 or US-A1-2002/0190636). If the layer sequence which has been applied to a substrate is shaped three-dimensionally for use using a thermoforming process followed by spraying, as is described in the abovementioned documents WO-A1-03/037039 and US-A1-2006/0061138, limits relating to the bending radii which occur in this case in the apparatus must be complied with in order to prevent damage to the layers and thus deterioration or even partial or complete failure of the lighting function. Since the layer sequence is applied to a substrate, when the overall apparatus comprising the optically active layer sequence and the substrate is bent, the neutral plane is shifted, which is neither stretched nor compressed, towards the substrate as a result of which those layers which are furthest away from the substrate in the layer sequence are loaded more severely during bending.

Furthermore, the substrate restricts the options for use of the electroluminescence apparatus, because it introduces an additional layer and an additional material into the apparatus, to which attention must be paid during use.

WO-A1-98/30069, which has already been cited, proposes an elastomeric electroluminescence lamp in which the electroluminescence apparatus, which is in the form of a lamp, is first of all produced on a transfer paper (transfer release paper 102) and is then provided with an adhesive layer (116) on the upper face. The electroluminescence apparatus can then either be transferred directly from the transfer paper to an application and integrated, or an adhesive layer is first of all applied to the upper face, for example containing a hot adhesive and ensuring permanent surface adhesion of the electroluminescence apparatus to substances, pieces of clothing or the like. In this case, however, the electroluminescence apparatus comprises not only the optically active layer sequence of the transparent front electrode (ITO layer 106), electroluminescence layer (108), dielectric layer (110) and rear electrode (112), but also a closed sheath, which comprises two comparatively thick sheathing layers (104, 114). The lower sheathing layer (104) is produced from polyurethane by repeated application (printing), in such a way that it results in a monolithic layer thickness after curing, and therefore acts as a mechanically robust substrate. This also applies to the upper sheathing layer (114). Overall, this results in a comparatively thick monolithic sheath which makes the electroluminescence apparatus mechanically naturally robust, independently of the transfer paper, but on the other hand restricts the options for use.

WO-A1-97/26673 also discloses a method for the production of an electroluminescence lamp in which a transparent substrate, which is coated with a transparent conductive layer, and a temporary substrate are produced separately, and a rear electrode, a dielectric layer and a phosphor layer are then successively applied to the temporary substrate using a rolling application technique, and both parts are finally laminated together with the phosphor layer on the conductive layer. On the one hand, splitting the production process between two substrates makes it possible to simplify the application of the layers. On the other hand, however, the choice of final substrates is greatly restricted because they must be suitable for supporting an electrode (in this case the transparent front electrode).

### SUMMARY OF THE INVENTION

The object of the invention is therefore to specify a method for the production of an electroluminescence apparatus as well as an electroluminescence apparatus which has been produced according to the method and is designed on the principle of an electrical capacitor, which avoid the disadvantages of known methods and are distinguished in particular by particular simplicity, and cover a considerably broader field of application.

The object is achieved by the totality of features in claims 1 and 22. The essence of the invention is to produce a functional layer sequence, which is reduced to what is absolutely necessary, comprising a rear electrode, an optically active dielectric and a front electrode, on an auxiliary mount, using very simple means, which layer sequence is not naturally robust because of its thinness, and can be applied to the final point of use only by direct transfer from the auxiliary mount. In particular, in this case, the assembly formed therein comprising the layer sequence and the substrate can be shaped three-dimensionally at the same time in the second step.

One refinement of the method according to the invention is characterized in that the first electrode layer, the intermediate layer and the second electrode layer are applied successively to the auxiliary mount within the first step, in that the individual layers of the layer sequence are printed onto the auxiliary mount by means of a printing method, and in that the layers of the layer sequence are printed onto the auxiliary mount by means of screen printing.

Another refinement is distinguished in that in order to form the optically active dielectric intermediate layer, at least one dielectric layer and one electroluminescence layer are applied to the auxiliary mount in this sequence or the opposite sequence.

As an alternative to this, in order to form the optically active dielectric intermediate layer, a dielectric material with inclusions which are embedded therein and can be excited for electroluminescence can be applied to the auxiliary mount.

According to one preferred refinement of the invention, at least one of the two electrode layers is in the form of an optically transparent electrode, with either the first electrode layer or the second electrode layer being in the form of an optically transparent electrode.

According to a further refinement, an additional layer can be applied first of all, before the layer sequence with the two electrode layers and the intermediate layer located between them is applied to the auxiliary mount, which additional layer can fulfill a very wide range of different objects. In particular, the additional layer may be an insulation and/or adhesion layer.

An separation layer can also be applied as the additional layer and enables or simplifies the separation of the layer sequence and the auxiliary mount.

In particular, the separation layer can remain on the auxiliary mount when the auxiliary mount is detached.

However, it is also feasible for the separation layer to be in the form of an electrically insulating layer and to remain as an insulating cover on the first electrode layer when the auxiliary mount is detached.

Furthermore, it is feasible that an insulation/adhesion layer is introduced between the layer sequence and the substrate, for insulation and/or better adhesion of the layer sequence on the substrate, with the insulation/adhesion layer preferably being applied to the second electrode layer before the second step.

According to another refinement of the invention, conductive organic materials, in particular conductive polymers, are used to form at least one of the electrode layers.

However, it is also feasible that conductive inorganic substances from the range comprising silver, carbon, indium tin oxide (ITO), pigments based on mica with a conductive sheath (Minatec®) are used to form at least one of the electrode layers.

A material from the range comprising wood, fabric, in particular wool or cotton, metal, plastic, in particular PVC, polyamide, polyester, polystyrene, PP; PUR, PE, polycarbonate, ABS, PMMA, rubber, paper, leather, cork and glass is preferably used as the substrate.

One preferred refinement of the electroluminescence apparatus according to the invention is characterized in that the overall thickness of the layer sequence is about 50 μm.

A particularly good stretching capability of the electroluminescence apparatus according to the invention, and thus far better flexibility and reliability in use can be achieved if, according to one particularly preferred refinement, the layers of the layer sequence each contain a highly flexible binding agent, in particular based on PU, PMMA, PVA.

According to one development, an additional layer with insulation and/or adhesion characteristics is arranged on at least one face of the layer sequence.

### BRIEF DESCRIPTION OF THE DRAWINGS

The invention will be explained in more detail in the following text with reference to exemplary embodiments and in conjunction with the drawing, in which:

FIG. 1 uses a number of figure elements 1(a) to 1(g) to show various steps in a production method according to a first exemplary embodiment of the invention;

FIG. 2 uses a plurality of figure elements 2(a) to 2(g) to show various steps in a production method according to a second exemplary embodiment of the invention, with the figure elements 2(f) and 2(g) relating to alternative refinements;

FIG. 3 uses a number of figure elements 3(a) to 1(f) to show various steps in a production method according to a third exemplary embodiment of the invention; and

FIG. 4 uses a plurality of figure elements 4(a) to 4(d) to show various steps in a production method according to a further exemplary embodiment of the invention, in which reinforcement of the transparent electrode layer is provided in order to make better contact.

### DETAILED DESCRIPTION OF THE INVENTION

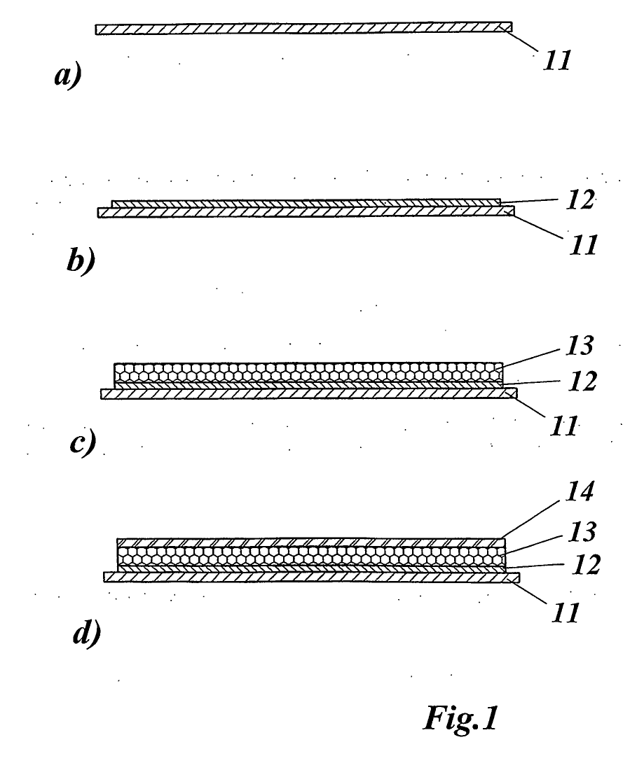

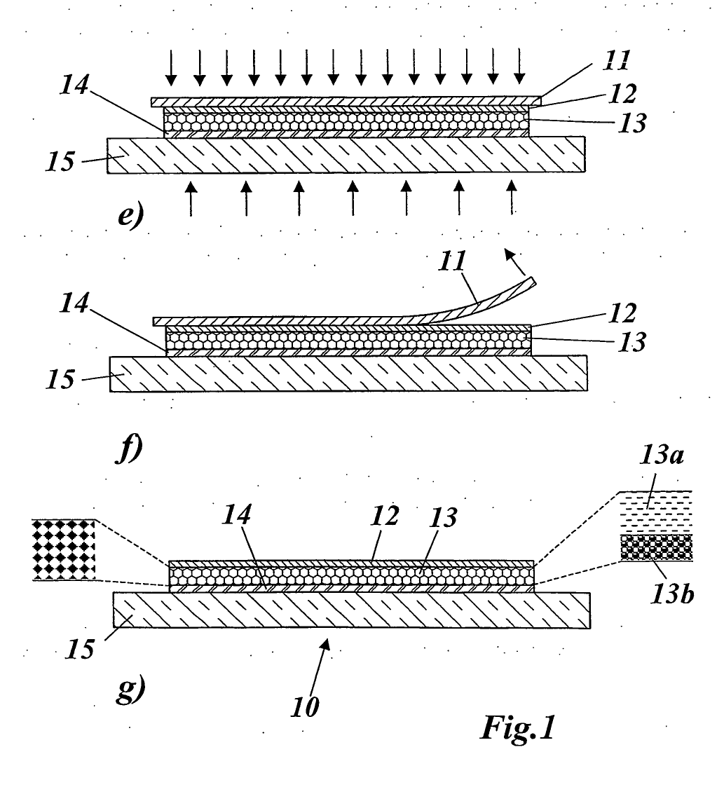

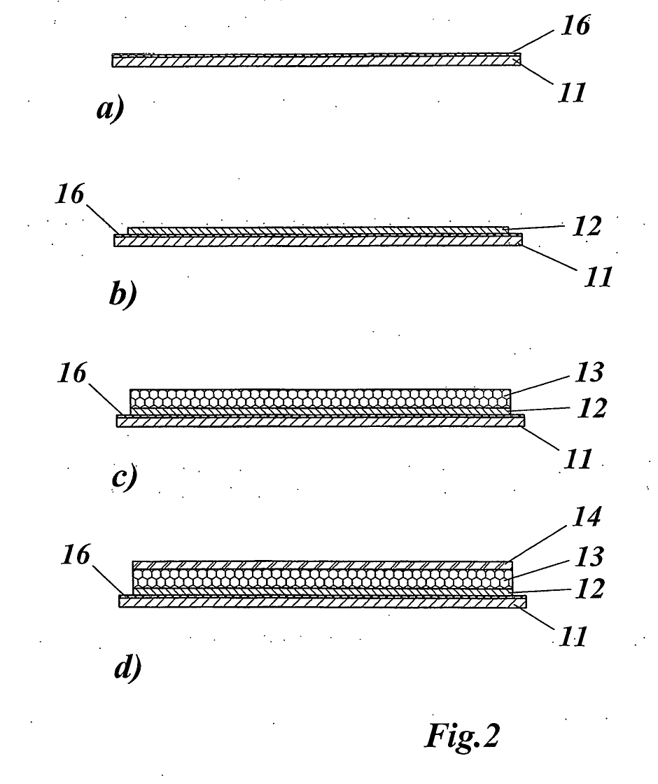

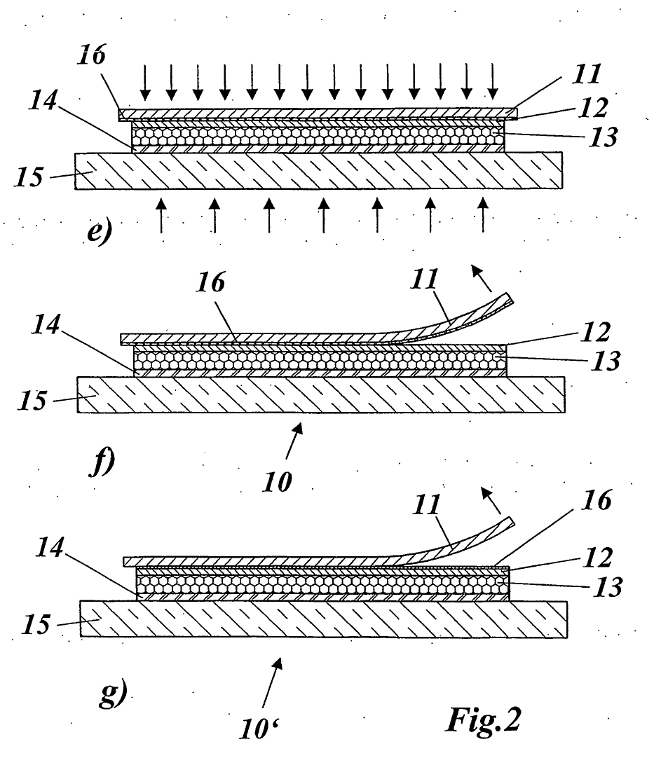

A plurality of simplified figure elements 1(a) to 1(g) in FIG. 1 show various steps in a production method according to a first exemplary embodiment of the invention. The method which is illustrated in FIG. 1 is based on an auxiliary mount 11 (which in particular is like a film) with anti-adhesion characteristics, for example a conventional baking paper or a lightly siliconized paper, as is used as a mount for self-adhesive labels (FIG. 1a). Other types of auxiliary mounts can, of course, also be used provided that they either themselves have anti-adhesion characteristics or—as explained further below in conjunction with FIG. 2—can be coated with a suitable separation layer. By way of example, it is feasible for the auxiliary mount 11 to be based on PUR, EP, co-polyamide, TPU, co-polyester, PP, PE or EVA.

A first electrode layer 12 (FIG. 1b) is applied, in particular by means of screen printing, to the auxiliary mount 11 in a first step. The nature of the first electrode layer 12 is governed by whether the electroluminescence apparatus (10 in FIG. 1g) is formed from the front face (illumination face) or from the rear face. If the electroluminescence apparatus 10 is formed from the front face, the first electrode layer 12 must be optically transparent. A multiplicity of different materials and options are available for this purpose. Organic and inorganic systems may be considered as transparent electrode materials:
organic, water-based: the intrinsically conductive polymer (ICP) which is known by the trade name Baytron®P with binding agents based on PU/polyester/polyether;
organic, solvent-based: the intrinsically conductive polymer (ICP) known by the name Ormecon® based on polyaniline;
inorganic: indium tin oxide (ITO);
inorganic: the lacquer pigment which is known by the trade name Minatec® and based on mica flakes, which are coated with an electrically conductive inorganic layer composed of a mixture of metal oxides.

If the electroluminescence apparatus 10 is formed from the rear face, the first electrode layer 12 may be opaque. In this case, Ag or C may be used as the electrode material and, for example, are dispersed as a filler in the form of powder in a suitable binding agent.

Once the first electrode layer 12 has dried or set, the optically active, dielectric intermediate layer 13 can be applied, likewise by means of screen printing (FIG. 1c). The intermediate layer 13, which contains the actual electroluminescence material, for example doped zinc sulfide crystals, may be in the form of a homogeneous layer, as is illustrated in the enlarged illustration on the left-hand side of FIG. 1g. The crystal grains are in this case homogeneously embedded in a matrix of dielectric material. However, the intermediate layer 13 may also be a layer sequence comprising at least one separate dielectric layer 13a (without electroluminescence material) and an electroluminescence layer 13b, as is indicated in the enlarged illustration on the right-hand side of FIG. 1g. In this case, the sequence of the two layers may change.

Once the intermediate layer 13 has been completed, the second electrode layer 14 can be applied by means of screen printing, as the next layer (FIG. 1d). If the second electrode layer 14 represents the rear electrode, Ag in particular can be used for this purpose. If, in contrast, it is the front electrode, the optically transparent materials mentioned above must be used in an appropriate manner. Apart from this, it is also feasible for both electrode layers 12, 14 to be optically transparent, such that, in principle, the electroluminescence apparatus 10 emits light on both faces.

The finished layer sequence 12, 13, 14 on the auxiliary mount 11 can now be transferred at its point of use to a (robust) substrate 15 that is provided there (FIG. 1e). In this case, the layer assembly 11, . . . , 14 from FIG. 1d is reversed, that is to say it is placed with the second electrode layer 14 on the substrate 15 first and is then connected over an area to the substrate 15, under the influence of pressure and/or heat (indicated by the arrows in FIG. 1e). FIG. 1 shows the substrate 15 as a simple flat plate. The substrate 15 may, of course, also be three-dimensionally contoured, as a result of which the layer assembly 11, . . . , 14 must be shaped and adapted three-dimensionally. In the same way, however, a three-dimensional shape or contour can also be applied at the same time during connection of the layer assembly 11, . . . , 14 and substrate 15 in order in this way to produce a three-dimensionally contoured or shaped electroluminescence apparatus from the initially flat layers 12, . . . , 14 and the initially flat substrate 15. The thinness of the layer sequence 12, . . . , 14, whose thickness is less than 100 μm, preferably about 50 μm, makes a significant contribution to the layer sequence being extraordinarily flexible and adaptable, and it can even be stretched comparatively far without the lighting function deteriorating or being entirely lost.

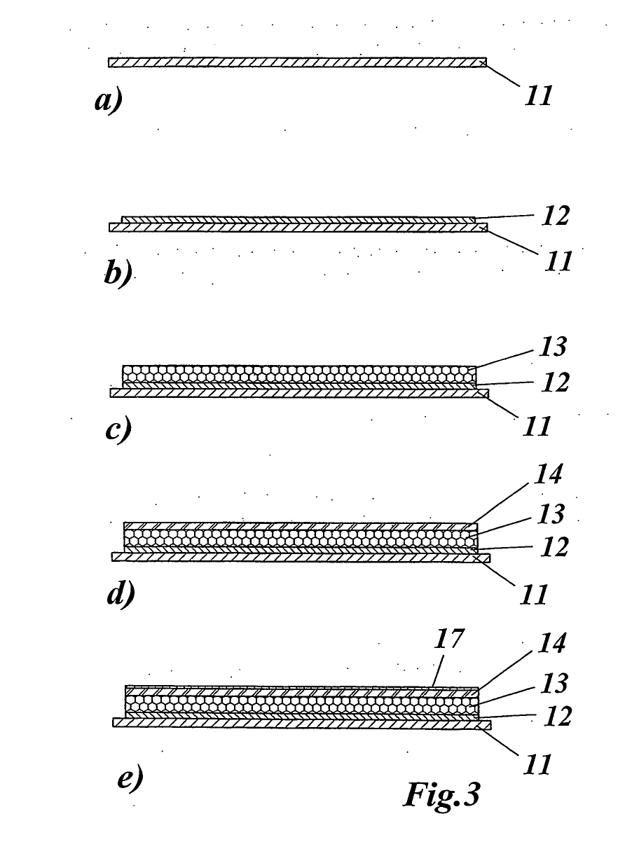

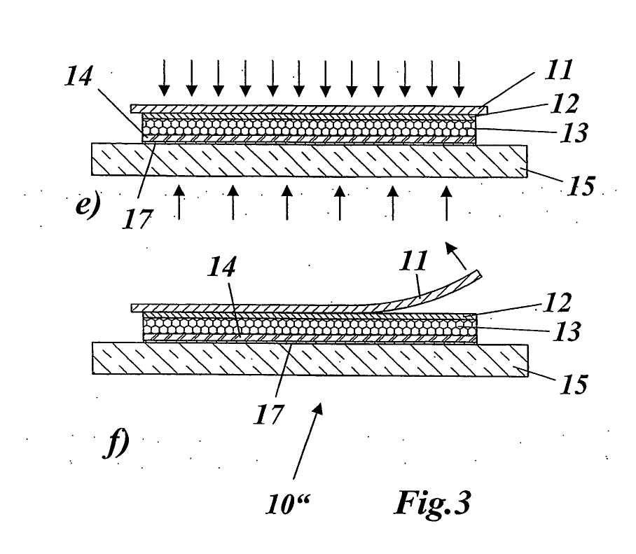

The layer sequence 12, . . . , 14 can be transferred as an entity or else partially onto substrates 15 composed of different materials. These materials may comprise substances (fabrics), wood, metal, in particular aluminum, paper, leather, cork, glass etc. If it is not possible to form an autonomous assembly between the second electrode layer 14 and the substrate in this case, an additional insulation/adhesion layer 17 must be provided between the two, as shown in FIG. 3. Assemblies are possible for substrates 15 composed of PVC, polyamide, polyester, polystyrene, PP, PUR, PE, polyamide, polycarbonate, ABS, PMMA, PS, rubber, neoprene, cellulose acetate, aramid, wool, cotton.

Once the layer sequence 12, . . . , 14 has been permanently adhesively connected to the substrate 15, the auxiliary mount 11 can be removed (FIG. 1f), as a result of which the substrate 15 remains, with the layer sequence 12, . . . , 14 adhering to it (FIG. 1g). Contact can be made with the two electrode layers 12 and 14 in a manner which is known per se and is not described in any more detail here. If the second electrode layer 14 is the (optically transparent) front electrode, the light passes through the substrate 15 provided that it is appropriately transmissive. For example, it is feasible to use as substrate 15 a thin wood veneer which is transparent because of its thickness, and accordingly can be illuminated from the rear. This allows attractive lighting effects to be produced for example in the case of wooden inserts in the interior of an automobile.

If the aim is for the electroluminescence apparatus 10 to be used as a display, graphics elements (scripts, arrows or the like) can be formed in the layer assembly and provide appropriate information. The graphics elements may be formed by suitable structuring of one or more of the layers 12, . . . , 14. However, it is also feasible to introduce further layers, for example covering layers or the like, which are provided exclusively in order to form the graphics elements.

Within the scope of the invention, it is also feasible, as shown in FIG. 2, to first of all provide the auxiliary mount 11 with an additional layer, in particular an separation layer 16 (FIG. 2a) before the same measures are carried out in the further steps (FIGS. 2b-2e) as those which have already been explained further above in conjunction with FIGS. 1b-1e. The separation layer 16 can be removed together with the auxiliary mount 11 on separation of the auxiliary mount 11 (FIG. 2f). This then results in the already known electroluminescence apparatus 10.

However, it is also feasible to leave the additional layer or separation layer 16 as (for example an electrically insulating) covering layer on the layer apparatus 12, . . . , 14 when the auxiliary mount 11 is separated (FIG. 2g). This then results in the electroluminescence apparatus 10′ whose first electrode layer 12 is covered on the outside. However, the additional layer may also have adhesion characteristics which are used when the layer apparatus 12, . . . , 14 is also intended to be connected to a substrate on this face.

Furthermore, as shown in FIG. 3 and analogously to FIGS. 1a-1d, it is feasible to apply the layer sequence 12, . . . , 14 to the auxiliary mount 11 first of all (FIGS. 3a-3d), but then to apply an insulation/adhesion layer 17 to the second electrode layer 14, which insulation/adhesion layer 17 may have an adhesion-promoting and/or insulating effect between the second electrode layer 14 and the substrate 15 (FIG. 3e). This results in the electroluminescence apparatus 10″ (FIG. 3f).

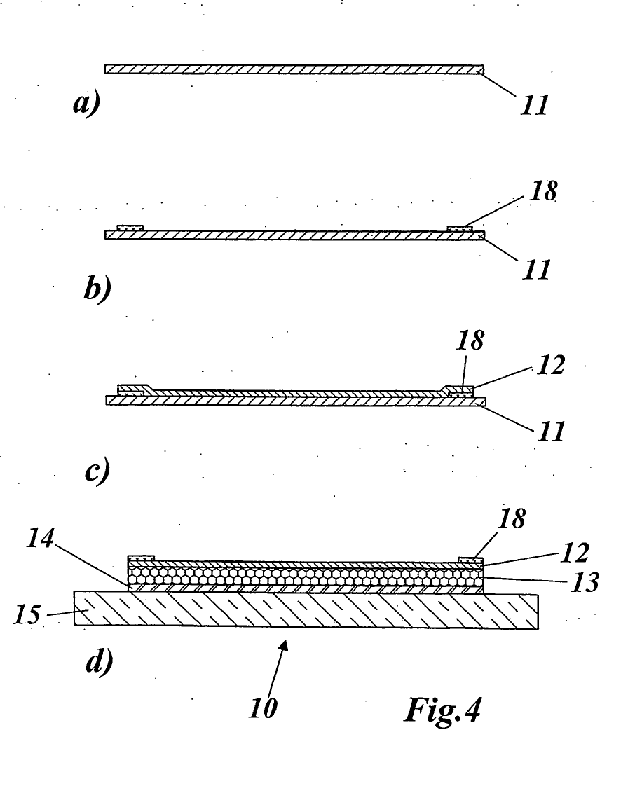

The optically transparent electrode layer of the layer apparatus 12, . . . , 14, that is to say for example the first electrode layer 12, is preferably applied very thin, with a thickness of about 5 μm. In order to allow a reliable and permanent contact in this case when contact is subsequently made with the electrode layer, an electrically highly conductive reinforcing layer is arranged in selected areas on the electrode layer, as is illustrated in FIG. 4 using the example of the first electrode layer 12. As shown in FIGS. 4a and 4b, the reinforcing layer 18 is first of all applied to the auxiliary mount, and its thickness is in the same order of magnitude as the thickness of the first electrode layer. In the example, the reinforcing layer 18 is in the form of an annular busbar which surrounds the entire surface, in order to allow contact to be made uniformly and with low resistance with the entire surface on the first electrode layer 12.

The first electrode layer 12 is then (FIG. 4c) printed on and this is then followed by the rest of the procedure according to the steps in FIGS. 1c to 1f in order finally to end, in the case of the electroluminescence apparatus 10 shown in FIG. 4d, with the reinforcing layer 18 applied to the transparent front electrode (electrode layer 12).

As has already been indicated further above, the electroluminescence apparatus is distinguished by particularly good flexibility and a good stretching capability without the individual layers becoming detached from one another, or cracking. The capability to stretch the apparatus can be enhanced even further if a specific material is chosen for the individual layers.

The material of the front electrode (electrode layer 12 or 14) may for this purpose in particular be an electrically conductive material on an inorganic or organic basis, for example Baytron® and/or polyaniline and/or polypyrrole, which is modified with highly flexible binding agents, for example based on PU, PMMA, PVA. By way of example, the dielectric intermediate layer 13 may then be composed of a mixture of ZnS, BaTiO3 and the highly flexible binding agents that have been mentioned. The material of the rear electrode (electrode layer 14 or 12) may then be an electrically conductive material on an inorganic or organic basis, for example Baytron® and/or polyaniline and/or polypyrrole, once again modified with highly flexible binding agents, for example based on PU, PMMA, PVA. In order to improve the electrical conductivity, the material of this electrode layer 14 or 12 may have silver or carbon added to it, and/or may have a layer composed of these materials added to it.

The composition of the individual layers 12 to 14 as described above ensures not only immovable adhesion of said layers to one another, but also a stretching capability, which it has not been possible to achieve in the past, of said layers of up to 100%.

1. A method for the production of an electroluminescence apparatus (10, 10′, 10″) which comprises a layer sequence (12, 13, 14), which is arranged on a substrate (15) and has two electrode layers (12, 14), and an optically active dielectric intermediate layer (13) which is located between the electrode layers (12, 14), comprising the steps of:
detachably applying the layer sequence (12, 13, 14) to an auxiliary mount (11);
adhesively applying the layer sequence (12, 13, 14) to the substrate (15) with the face which faces away from the auxiliary mount (11) of the layer sequence (12, 13, 14) which is located on the auxiliary mount (11); and
detaching the auxiliary mount (11) from the layer sequence (12, 13, 14), which adheres to the substrate (15).

2. The method as claimed in claim 1, wherein the first electrode layer (12), the intermediate layer (13) and the second electrode layer (14) are applied successively to the auxiliary mount (11) within the first step.

3. The method as claimed in claim 2, wherein individual layers of the layer sequence (12, 13, 14) are printed onto the auxiliary mount (11) by means of a printing method.

4. The method as claimed in claim 3, wherein the individual layers of the layer sequence (12, 13, 14) are printed onto the auxiliary mount (11) by means of screen printing.

5. The method as claimed in claim 4, wherein in order to form the optically active dielectric intermediate layer (13), at least one dielectric layer (13a) and one electroluminescence layer (13b) are applied to the auxiliary mount (11) in this sequence or an opposite sequence.

6. The method as claimed in claim 4, wherein in order to form the optically active dielectric intermediate layer (13), a dielectric material with inclusions which are embedded therein and can be excited for electroluminescence is applied to the auxiliary mount (11).

7. The method as claimed in claim 6, wherein at least one of the two electrode layers (12, 14) is in the form of an optically transparent electrode.

8. The method as claimed in claim 7, wherein the first electrode layer (12) is in the form of an optically transparent electrode.

9. The method as claimed in claim 7, wherein the second electrode layer (14) is in the form of an optically transparent electrode.

10. The method as claimed in claim 9, wherein in order to make better contact, the electrode layer (12, 14) which is in the form of a transparent electrode is reinforced with a conductive reinforcing layer (18) in selected areas.

11. The method as claimed in claim 1, wherein an additional layer (16) is applied first of all, before the layer sequence (12, 13, 14) with the two electrode layers (12, 14) and the intermediate layer (13) located between them is applied to the auxiliary mount (11).

12. The method as claimed in claim 11, wherein the additional layer is an insulation and/or adhesion layer.

13. The method as claimed in claim 11, wherein a separation layer (16) is applied as the additional layer and enables or simplifies the separation of the layer sequence (12, 13, 14) and the auxiliary mount (11).

14. The method as claimed in claim 13, wherein the separation layer (16) remains on the auxiliary mount (11) when the auxiliary mount (11) is detached.

15. The method as claimed in claim 13, wherein the separation layer (16) is in the form of an electrically insulating layer, and remains as an insulating cover on the first electrode layer (12) when the auxiliary mount (11) is detached.

16. The method as claimed in claim 1 wherein an insulation/adhesion layer (17) is introduced between the layer sequence (12, 13, 14) and the substrate (15), for insulation and/or better adhesion of the layer sequence (12, 13, 14) on the substrate (15).

17. The method as claimed in claim 16, wherein the insulation/adhesion layer (17) is applied to the second electrode layer (14) before the second step.

18. The method as claimed in claim 1 wherein conductive organic materials, in particular conductive polymers, are used to form at least one of the electrode layers (12, 14).

19. The method as claimed in claim 1 wherein conductive inorganic substances from the range comprising silver, carbon, indium tin oxide (ITO), pigments based on mica with a conductive sheath (Minatec®) are used to form at least one of the electrode layers (12, 14).

20. The method as claimed in claim 1 wherein a material from the range comprising wood, fabric, in particular wool or cotton, metal, plastic, in particular PVC, polyamide, polyester, polystyrene, PP; PUR, PE, polycarbonate, ABS, PMMA, rubber, paper, leather, cork and glass is used as the substrate (15).

21. The method as claimed in claim 1 wherein in the adhesively applying step, the assembly formed therein comprising the layer sequence (12, 13, 14) and the substrate (15) is shaped three-dimensionally at the same time.

22. An electroluminescence apparatus (10, 10′, 10″) produced according to a method as claimed in claim 1 which has a layer sequence (12, 13, 14), which is arranged on a substrate (15), having two electrode layers (12, 14) and an optically active, dielectric intermediate layer (13) which is located between the electrode layers (12, 14), characterized in that the layer sequence (12, 13, 14) has an overall thickness of less than 100 μm.

23. The electroluminescence apparatus as claimed in claim 22 wherein the overall thickness of the layer sequence (12, 13, 14) is about 50 μm.

24. The electroluminescence apparatus as claimed in claim 22 wherein the layers (12, 13, 14) of the layer sequence (12, 13, 14) each contain a highly flexible binding agent, in particular based on PU, PMMA, PVA.

25. The electroluminescence apparatus as claimed in claim 24 wherein an additional layer (16, 17) with insulation and/or adhesion characteristics is arranged on at least one face of the layer sequence (12, 13, 14).
